(19) United States
(12) Patent Application Publication
(10) Pub. No.: US 2016/0033644 A1
(43) Pub. Date: Feb. 4, 2016

(54) TIME OF FLIGHT DETERMINATION

(71) Applicant: STMicroelectronics (Research & Development) Ltd., Marlow (GB)

(72) Inventor: John Kevin Moore, Edinburgh (GB)

(73) Assignee: STMicroelectronics (Research & Development) Ltd., Marlow (GB)

(21) Appl. No.: 14/734,138

(22) Filed: Jun. 9, 2015

(30) Foreign Application Priority Data
Jul. 31, 2014 (GB) 1413564.4

(51) Int. Cl. G01S 17/08; G01S 7/48

(52) U.S. Cl. CPC G01S 17/08; G01S 7/4808

(57) ABSTRACT

First events corresponding to detecting a reflection off a reference object are detected. Second events corresponding to detecting a reflection off a remote object are also detected. A histogram having a first peak corresponding to the first events and a second peak corresponding to the plurality of second events is generated. A distance between the remote object and the reference object is determined in dependence on a time between the first peak and the second peak of the histogram.

### PRIORITY CLAIM

This application claims priority from Great Britain Application for Patent No. 1413564.4 filed Jul. 31, 2014, the disclosure of which is incorporated by reference.

### TECHNICAL FIELD

The present disclosure relates to the determination of a distance to a remote object using time of flight.

### BACKGROUND

Time of flight may be used to determine a distance between a reflective object and a housing of a device having a light emitter and sensor. In time of flight, a pulse of light is emitted and reflected off an object back to a sensor. The time taken for the light to travel to the object and be reflected back onto a sensor may be used to determine the distance between the object and the device based on the known speed of light.

Time of flight calculations may be implemented in situations where it is useful to know the distance between an object and a device. One example is in mobile telephones incorporating touch screens. In this example, when receiving or making a phone call, part of a user's face may touch the touchscreen in order to place the ear in the vicinity of the speaker. During the call, the touchscreen should be non-responsive to the user's face in order to prevent accidental hanging up. Time of flight calculations may be carried out in order to determine that this is the case and disable the touch screen.

Single photon avalanche diodes (SPAD) may be used as an indicator of reflected light. In general an array of SPADs is provided as a sensor in order to detect a reflected light pulse. A photo generated carrier (such as a photon in the light pulse) may trigger an avalanche current in one or more of the SPADs in an SPAD array. The avalanche current may signal an event, namely that a photon of light has been detected.

Time of flight determination circuitry may be one of many circuitry implemented in a device. Thus the size of the time of flight determination circuitry, and associated module or housing, may be of concern.

### SUMMARY

According to a first aspect, there is provided a method comprising: determining a plurality of first events corresponding to detecting a reflection off a reference object; determining a plurality of second events corresponding to detecting a reflection off a remote object; generating a histogram having a first peak corresponding to the plurality of first events and a second peak corresponding to the plurality of second events; and determining a distance between the second object and the reference object in dependence on a time between the first peak and the second peak.

The method may further comprise emitting a series of light pulses that cause the plurality of first and second events. The reference object may be part of a sensing device. Each of the plurality events may comprise an indication that an event has occurred and an event time occurred. Event time may comprise a time period between a light pulse being triggered and the event being determined.

The histogram may be generated by a time to digital converter. The histogram may comprise an indication of the likelihood of an event occurring against time. The time between the first peak and the second peak of the histogram may be indicative of a distance between the remote object and the reference device. Determining the plurality of first and second events may be carried out by a first sensor array. The reference object may be at a known distance to an emitter of the light.

The method may further comprise: determining a plurality of further events corresponding to detecting a reflection off a further remote object; generating the histogram further having a further peak corresponding to the plurality of further events; and determining a distance between the further remote object and the reference object in dependence on a time between the first peak and the further peak.

According to a second aspect, there is provided an apparatus comprising at least one processor and at least one memory including computer program code for one or more programs, the at least one memory and the computer program code configured to, with the at least one processor, cause the apparatus to at least to carry out the steps of: determining a plurality of first events corresponding to detecting a reflection off a reference object; determining a plurality of second events corresponding to detecting a reflection off a remote object; generating a histogram having a first peak corresponding to the plurality of first events and a second peak corresponding to the plurality of second events; and determining a distance between the second object and the reference object in dependence on a time between the first peak and the second peak.

The apparatus may further comprise: an emitter configured to emit light for a detection period; and a sensor for detecting reflected light and providing event information relating to the detected of light. The apparatus may further comprise: a time to digital converter for providing time and event information corresponding to the detected light.

The emitter may be further configured to emit a series of light pulses that cause the plurality of first and second events. The apparatus may further comprise the reference object. The apparatus may be a range sensing device. Each of the plurality events may comprise an indication that an event has occurred and an event time occurred and is provided by the time to digital converter. An event time may comprise a time period between a start time of a detection period being triggered and said event being determined. The series of light pulses may form a sinusoidal wave form.

The time to digital converter may be further configured to generate the histogram. The processor may be further configured to generate the histogram. The histogram may comprise an indication of the likelihood of an event occurring against time. The time between the first peak and the second peak of the histogram may be indicative of a distance between the remote object and the reference device. The sensor may be a single photon avalanche diode array. The reference object may be at a known distance to the emitter.

The apparatus may be further configured to carry out the steps of: determining a plurality of further events corresponding to detecting a reflection off a further remote object; generating the histogram further having a further peak corresponding to the plurality of further events; and determining a distance between the further remote object and the reference object in dependence on a time between the first peak and the further peak.

According to a third aspect, there is provided a computer program product for a computer, comprising software code portions for performing the steps of: determining a plurality of first events corresponding to detecting a reflection off a reference object; determining a plurality of second events corresponding to detecting a reflection off a remote object; generating a histogram having a first peak corresponding to the plurality of first events and a second peak corresponding to the plurality of second events; and determining a distance between the second object and the reference object in dependence on a time between the first peak and the second peak.

The software code portions may be further configured to perform the steps of emitting a series of light pulses that cause the plurality of first and second events. The reference object may be part of a sensing device. Each of the plurality events may comprise an indication that an event has occurred and an event time occurred. Event time may comprise a time period between a light pulse being triggered and the event being determined. The histogram may be generated by a time to digital converter. The histogram may comprise an indication of the likelihood of an event occurring against time.

The time between the first peak and the second peak of the histogram may be indicative of a distance between the remote object and the reference device. The determining the plurality of first and second events may be carried out by a first sensor array. The reference object may be at a known distance to an emitter of the light.

The software code portions may be further configured to perform the steps of: determining a plurality of further events corresponding to detecting a reflection off a further remote object; generating the histogram further having a further peak corresponding to the plurality of further events; and determining a distance between the further remote object and the reference object in dependence on a time between the first peak and the further peak.

### BRIEF DESCRIPTION OF THE DRAWINGS

Embodiments of the present application will now be described with reference to the following figures in which:

FIG. 1 is a schematic diagram showing an example of a time of flight detector having two SPAD arrays;

FIG. 2 is a schematic diagram showing an example of a time of flight detector according to a first embodiment;

FIG. 3 is an example of a histogram according to an embodiment;

FIG. 4 is a flow diagram depicting the method steps associated with an embodiment;

FIG. 5 is a flow diagram depicting the method steps associated with a further embodiment;

FIG. 6 is an example of peak detection according to an embodiment;

FIG. 7A is an example of a time of flight detector with two remote objects; and

FIG. 7B is a histogram corresponding to the detection of FIG. 7A.

### DETAILED DESCRIPTION OF THE DRAWINGS

The distance between a device and an object can be calculated if a time that it takes light to travel between the device and the object is known. In time of flight (ToF) applications a light emitter in a device may emit a pulse of light and a sensor of the device may detect the pulse after it has reflected off a remote object. The time at which the pulse of light was emitted and the time at which the reflected light was detected may be used to determine the time taken for the light pulse to travel to the remote object and back. Using the speed of light constant c, the distance between the remote object and the device comprising the emitter/sensor may be calculated.

A light emitter used for ToF may be driven by a driver. In order to emit a pulse of light, a trigger (signal) may be provided to the emitter driver from a processor in order to trigger the pulse. In response to the trigger the driver may turn on and then prepare to output the light pulse. While the processor may be aware of a time, for example through a system clock, a delay due to the driver response time and trigger propagation time may be incurred. This delay may for example further vary with process, voltage and temperate (PVT) variations. The time at which a light pulse is emitted may therefore not always be accurately known.

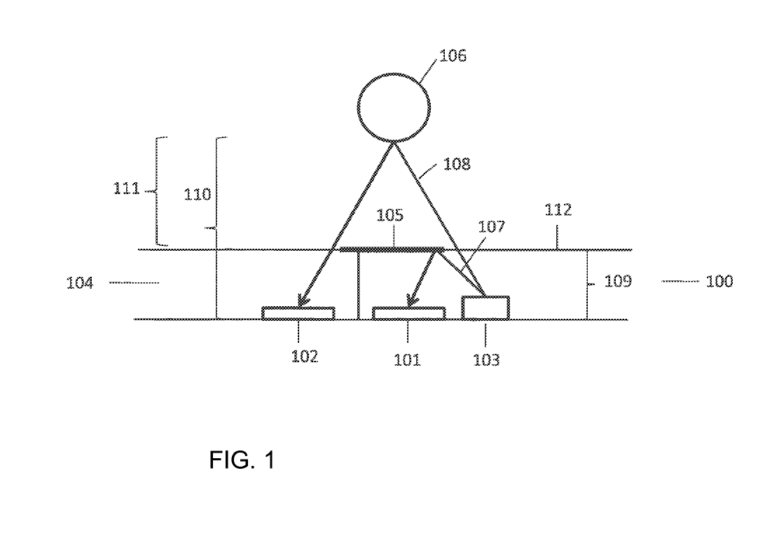

One method of overcoming this is to provide a reference time to compensate for the driver response time and PVT variations. FIG. 1 shows an example of this.

FIG. 1 comprises a device 100 having a first sensor 101, a second sensor 102 and a light emitter 103. The emitter 103, first sensor 101 and second sensor 102 may be in a housing 104 with a reference reflective object 105. The reference reflective object 105 may be at a fixed distance from the first sensor 101—in this case, the reference reflective object is on a surface of the housing. The device 100 may be configured to determine a distance between the device 100 and a remote object 106. The light emitter 103 may emit one or more pulses of light.

A first path of the emitted light 107 is shown. Along path 107, light is emitted from the emitter 103 and is reflected off the reference reflective object 105 and onto the first sensor 101. A second path of the emitted light 108 is also shown. Along path 108, the light is emitted from the emitter 103 and reflected off the remote object 106 and onto the second sensor 102. It will be appreciated that the light along path 107 and 108 is emitted as part of a same pulse from the emitter 103 and can both be considered to be emitted simultaneously.

The first sensor 101 may detect the incidence of the light from path 107 and indicate a time (t1) at which the light was detected. The time t1 is the time taken for the light to travel along the path 107 and thus twice the distance shown at 109. The second sensor 102 may detect the incidence of light from the path 108 and indicate a time (t2) at which the light was detected. The time t2 is the time taken for the light to travel along the path 108 and thus twice the distance 110.

It will be appreciated that the time t1 and the time t2 may be determined by a clock of the device. The time t1 may be determined based on a timer that starts counting when a pulse of light is triggered and stops on detection of an event (the incidence of the reflected light) and the first sensor 101. Similarly, the time t2 may be determined based on a timer that starts counting when a pulse of light is triggered and stops on detection of an event (the incidence of the reflected light) on the second sensor 102. It will be appreciated that in some embodiments the timer for t1 and for t2 may be the same timer.

The time at which the pulse of light is triggered may not be equivalent to the time at which the pulse is actually emitted and thus each of the times t1 and t2 may include a reaction time of the emitter. In order to compensate for the reaction time, a difference between the time t2 and the time t1 is used to calculate the distance of the second object from the device. By subtracting t2 and t1, the reaction time is cancelled.

The difference between the time t1 and the time t2 is the time taken for the light to travel along path 108 minus the time taken for the light to travel along the path 107. Hence the difference (t3) between the time t2 and t1 is the time taken for the light to travel from the reference reflective object 105 to the remote object 106 and back to the reference reflective object 105. The distance between the reference reflective object 105 (and thus the surface 112 of the device housing) and the remote object 106 is shown as the distance 111.

The resulting time t3 may be used to calculate the distance from the device 100 and specifically the surface 112 of the device 110 (location of the reference reflective object 105), to the remote object 106. It will be appreciated that the reference reflective object 105 is at a known distance from the sensor and thus the distance of the remote object 106 from the sensors 102 and 101 may be calculated by adding this known distance to the distance calculated using t3.

It will be appreciated that while not shown, the first sensor 101 and the second sensor 102 may be further coupled to analog or digital circuitry for the determination of the time and calculation of the distance of the second remote object 106.

It can be seen from FIG. 1 that the device incorporates two sensors 101 and 102. However it will be appreciated that the device may have a limited space for the incorporation of such sensors. Additionally, it is possible that sensors 101 and 102 may exhibit slightly different signal delays due to, for example, differences in the manufacture of the sensors which may contribute to an inaccuracy in the time information.

Embodiments of the present application propose time of flight circuitry having a single sensor and a determination method for determining the distance of a remote object on the basis of a single sensor and a reference reflective object at a known distance from the sensor.

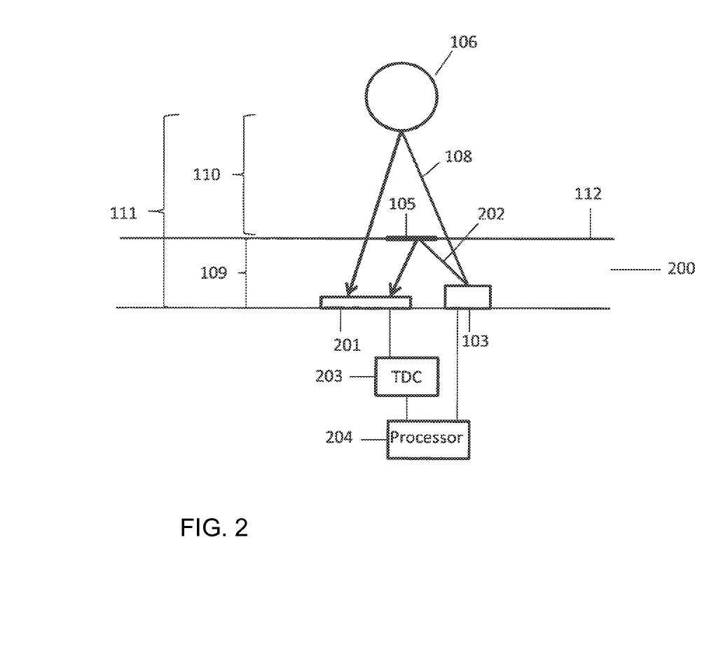

FIG. 2 is a schematic diagram showing a device according to a first embodiment.

FIG. 2 comprises a device 200 comprising an emitter 103, a first reflective surface 102, a device surface 112. It will be appreciated that in some respects, the device 200 of

FIG. 2 is similar to the device 100 of FIG. 1 and like reference numerals may depict this. Instead of the first and the second sensor 101 and 102 of FIG. 1, however, the device of FIG. 2 comprises a single sensor 201.

FIG. 2 further comprises a time to digital converter (TDC) 203 and a processor 204. The TDC 203 is shown coupled to the sensor 201 and the processor 204 however it will be appreciated that in some embodiments, the TDC 203 may form part of the processor 204, in other embodiments the TDC 203 may incorporate the processing functions necessary to carry out embodiments.

In the example of FIG. 2, the emitter 103 may emit a pulse of light. The light may follow a first path 202, reflecting off the first reflective object 105 and onto the sensor 201.

The light may additionally follow a second path 108, reflecting off the remote object 106 and onto the sensor 201. The incidence of the light on the sensor 201 may indicate an event and the sensor and/or TDC 203 may output a time at which the event occurred. It will be appreciated that the time recorded for the event may correspond to a time period from the triggering of a pulse to the incidence of light on the sensor and may include a reaction time for the emitter to emit the pulse of light.

In embodiments, the TDC 203 and processor may use this time and event information to generate a histogram having a first peak corresponding to the time taken for path 202 and a second peak corresponding to a time taken for path 108. By taking a time difference between the two peaks, a distance from the first reflective object to the remote object may be calculated and the reaction time may be negated.

In operation, a first event detected by the sensor 201 may be the incident of the light along path 202 on the sensor 201 and a second event detected by the sensor 201 may be the incident of the light along path 108 on the sensor 201. The sensor may be able to detect multiple events for a pulse of light.

Information relating to a detected event and a time at which the event was detected may be passed to a time to digital converter which may provide a digital representation of the information. It may be appreciated that the time to digital converter may receive an indication of an event from the sensor 201 and provide a digital indication of the event along with a time. For example, the TDC 201 may be further coupled to a clock.

The processor may receive these digital indications and build up a histogram depicting the number of events that have occurred at each time. Using the histogram a single sensor may be used to determine both the reference time (the time to travel path 202) as well as the time of flight to the second object 106.

The processor 204 may receive information that an event has occurred and a time at which the event has occurred. The processor may gather this information and use it to generate a histogram. It will be appreciated that in order to gather enough information to generate a histogram a plurality of light pulses may be emitted in the determination of a distance from the remote object 106. Event information may be detected for one or more of the plurality of pulses and the information may be combined by the processor to generate a histogram.

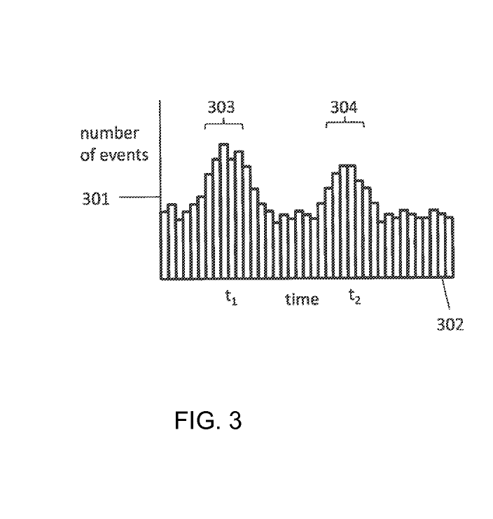

FIG. 3 shows an example of a histogram.

The histogram of FIG. 3 shows the number of events 301 that have been detected at a given time 302. It will be appreciated that the information in the histogram of FIG. 3 may represent the events detected over a number of pulses.

It will be appreciated that the processor may trigger the start of a pulse. The time at which the pulse was triggered may be known, however due to driver reaction time and PVT variations, the time at which the pulse is emitted is not accurately known. For each pulse, the time of the event 302 may be considered to be the time between the pulse being triggered and the event being detected. Thus, event information for each of a plurality of pulses may include an indication of an event and a time corresponding to a time period of between the triggering of a pulse the event occurring.

FIG. 3 shows a first peak 303 and a second peak 304. The first peak 303 may represent the events (first events) detected during each pulse period due to the reflected of the reference reflective object 105, in other words the events due to the light along path 202. It can be seen that the first peak 303 centers around time t1, which is the time taken for the light to travel between the emitter, the reference reflective object 105 on the surface 112 of the device 200 and the sensor 201.

The second peak 304 may represent the events (second events) detected during each pulse period due to the reflected of the remote object 106, in other words the events due to the light along path 108. It can be seen that the second peak 304 centers around time t2, which is the time taken for the light to travel between the emitter 103, the remote object 106 and the sensor 201.

It will be appreciated that the number of events detected at the times surrounding t1 and t2 may not be null. This is because other incidences of light may occur onto the sensor. For example, light from other sources may be incident on the sensor and/or light having a longer reflection path may fall onto the sensor.

It will be appreciated that event data is gathered for each pulse period and then event data from all the pulse periods are combined. The emitter may emit a number of pulses during a detection period and data is gathered for each of the pulse periods in the detection period. For each pulse period time and event information comprising an indication of any event and an associated time (corresponding to a period of time between that pulse being triggered and an event detected) will be gathered for the events occurring during the pulse period. The time and event information for each pulse period will be combined to generate the histogram.

In this case a pulse period may include both the period for which a light pulse occurs as well as a period of time between the pulse and the next pulse. In one example, a pulse may be 2 ns long and there may be a 10 ns break between pulses. In this example, the pulse period is 12 ns. It will however be appreciated that this is by way of example only and a pulse period may be chosen based on component capability and/or the distance desired to be detected and dependent on the application of the device.

Once the time and event information is gathered from the pulses in the detection period and the histogram is generated, the distance between the remote object and the device may be determined from the time difference between the first peak 303 and the second peak 304. An average or mean time at which the first events occurred and an average or mean time at which the second events occurred may be determined and used to determine distance of the second object. It will be appreciated that different methods to detect the peaks may be used. For example a highest number of events per time may be used to detect a peak or an average number of events per time period may be used.

It will be appreciated that the difference between t1 and t2 will correspond to the time taken for light to travel from the surface 112 (position of the reference reflective object 105) to the remote object 106 and back to the surface 112, hence the distance to the remote object 106 based on this will be the distance from the surface 112 of the device. It will however be appreciated that the distance between the sensor 201 and the reference reflective object 105 (surface 112) is a fixed distance. Thus the distance from the sensor 201 to the remote object 106 may be determined by the addition of this fixed distance if desired.

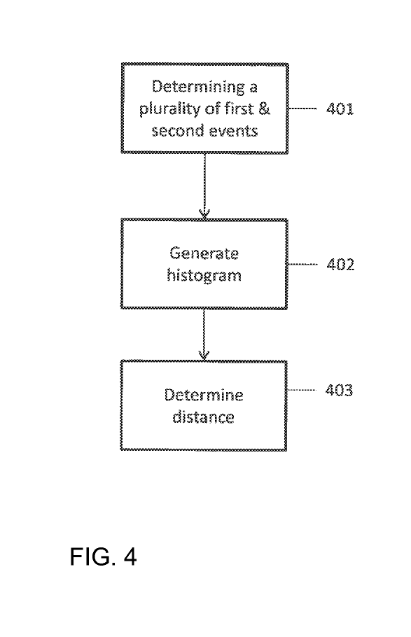

FIG. 4 shows an example of the method steps that may be carried out in accordance with some embodiments.

At step 401, a plurality of first events and second events are determined and a time at which each event occurred is recorded. It will be appreciated that the histogram may be updated as event data is received and thus event data is recorded in the histogram. It will also be appreciated that the event data may be recorded for a series of pulses in a detection period and the event time may be relative to each pulse.

At step 402, a histogram may be generated from the event information. It will be appreciated that in some embodiments, the histogram may be generated once the detection period has ended and based on all the time and event information for the detection period. In other embodiment the histogram may be generated during the detection period and updated as the time and event information is generated. In some embodiments the histogram may be generated by the processor in response to digital time information from the TDC 203. In other embodiments, the TDC may generate the histogram.

At step 403, the time difference between a first peak 303 corresponding to the first events and a second peak 304 corresponding to the second events of the histogram may be used to determine a time taken for light to travel to and from the remote object 106 from the reference reflective object 105 on the device 200. In some embodiments this may be the time taken for light to travel from the surface 112 to the remote object 106 and back. It will be appreciated that this time may be used to determine a distance between the remote object 106 and the device 200.

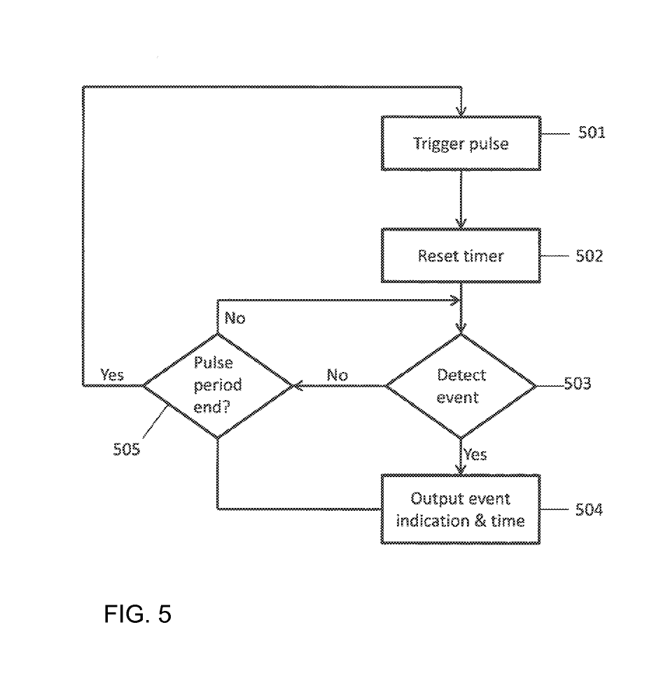

It will be appreciated that at step 401 a series of light pulses may be used to generate enough event data to generate the histogram. FIG. 5 shows the method steps associated with the series of pulses according to some examples.

At step 501 of FIG. 5 a first pulse is triggered and a timer is reset at 502. It will be appreciated that the timer will be reset at the time at which the pulse is triggered and not necessarily at the time at which the pulse is actually emitted. It will also be appreciated that in some cases, these steps 501 and 502 will be carried out simultaneously.

At step 503, it is determined whether an event is detected by the sensor 201. If an event is detected, an indication of the detected event is passed to the TDC 203 where an event time is recorded at step 504. It will be appreciated that the time may correspond to the timer and thus a time period from triggering the first pulse. The method then proceeds to step 505. If no event is detected at 503, the method will also proceed to step 505.

At step 505 it is determined if the pulse period has ended. In other words it is determined whether it is possible for more events to occur due to the first pulse or if it is time for a second pulse. The pulse period may for example include the time of the pulse as well as a time between pulses. If the pulse period has not ended, the method proceeds to step 503 where more events are detected and output.

If the pulse period has ended at 505, the method proceeds back to steps 501 and 502 where a second pulse may be generated. In this manner a series of pulses forming a detection period may be generated and event and time information for the detection period may be provided to be used to generate a histogram. The method of FIG. 5 will exit when all the pulses in the detection period have been generated.

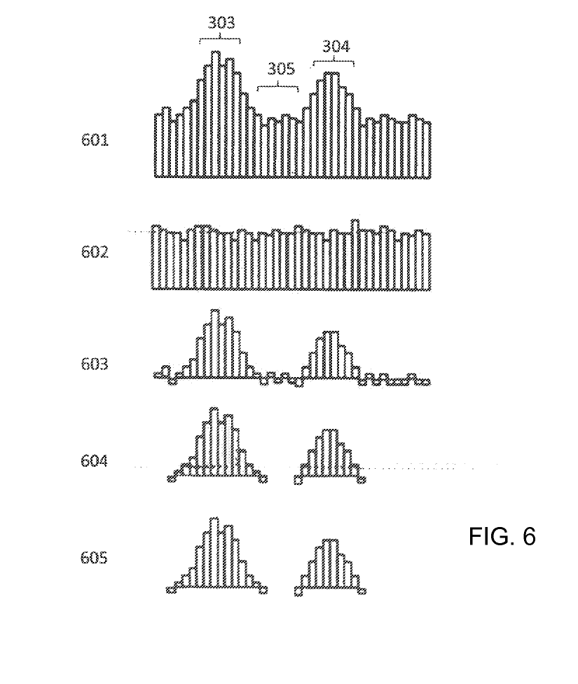

A resulting histogram is built, with an example given in FIG. 6. In order to determine a time between a first peak 303 and a second peak 304, the processor is configured to determine the locations of the first and second peaks. It will be appreciated that the processor may detect the position of the peaks and hence the time between the first peak and the second peak in any suitable fashion, however FIG. 6 shows one example of such a determination.

In the example of FIG. 6, four stages are carried out in the determination of a time difference between the first peak 303 and the second peak 304. A first stage 602 may occur prior to detection period and may comprise consist of building a histogram depicting an average event information triggered by ambient light. It will be appreciated that event with no triggered pulse, events may be detected on the sensor 201 due to ambient light in the environment. In this example a separate timed sequence may be run with no light pulse emitted by the emitter 103. A histogram may be generated by the processor showing the number of events against time detected under ambient light conditions.

After the first stage, a method such as that described in FIGS. 4 and 5 may be carried to generate a histogram generated in response to the detection period. This may be a histogram for example the histogram of FIG. 3 and is shown at 601.

A second stage may occur after the generation of the histogram of FIG. 3 and is shown at 603. The second stage may comprise subtraction of the expected average events caused by ambient light from the event information in the histogram generated from the detection period. It will be appreciated that this may be done on a bin by bin basis.

A third stage may comprise thresholding and is shown at 604. In the third stage 604, the approximate locations or times of the first and second peaks is established. The processor may determine whether event information is unlikely to be due to a reflected pulse and remove such data from the histogram. For example, very low levels or negative amounts of detected events may be removed.

In the fourth stage, a center of each remaining discrete peak may be found through for example peak detection and/or by a center of mass calculation and is shown at 605.

In the example of FIG. 6, the first peak 303 and the second peak 304 may be separated in time. For example there is a distinctive low 305 between the peaks 303 and 304. This separation is due to the magnitude of the distance between the reflective reference object and the remote object. It follows that a greater distance between the reference reflective object and the remote object leads to a greater space 305 between the first and second peaks 303 and 304. It will be appreciated that in peak determination in the example of FIG. 6 may be appropriate for cases where the first and second peak are spaced apart. However in some cases, for example where the reference reflective object and the remote object are close together, the first and second peaks may overlap. In such cases, more complex algorithms may be used to resolve pulses overlapping in time. For example the histogram data may be low pass filtered and then differentiated to detect a change in the response.

It will be appreciated that while in the foregoing the distance to a single remote object is calculated, in further embodiments there may be more than one remote object and multiple distances may be determined using the sensor 201 and the reference reflective object 105. For example a first distance may be determined between a first remote object from the reference object, a second distance may be determined between a second remote object from the reference object and further distances to further remote objects may be calculated using a histogram generated during a detection period.

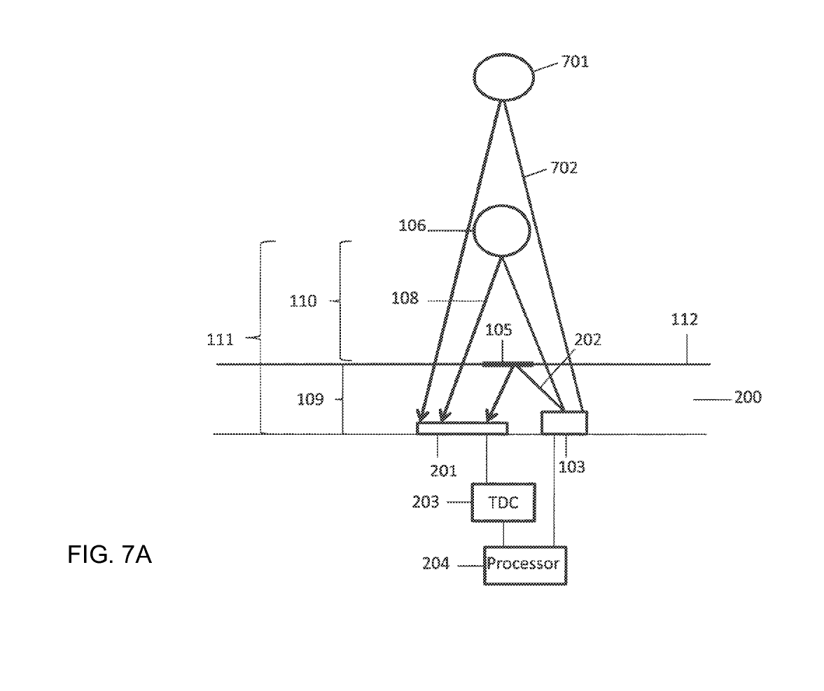

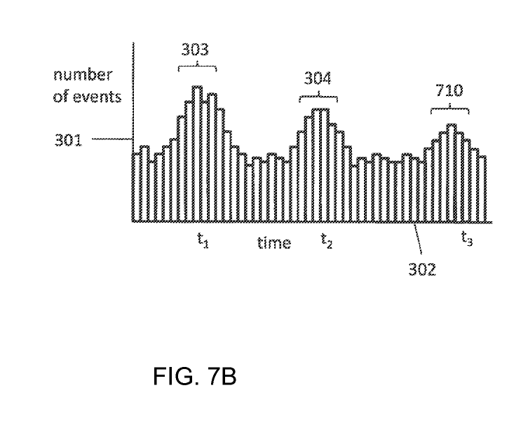

FIGS. 7A and 7B give an example of embodiments where respective distances to more than one remote object are determined. FIG. 7A shows a schematic diagram of a device 200 and a first remote object 106 and a second remote object 701. It will be appreciated that in FIGS. 7A and 7B like reference numerals indicate like components as depicted in FIG. 2.

FIG. 7A comprises a first remote object 106 and a second remote object 701. A path of light from the emitter 103 reflected off the first remote object 106 and onto the sensor 201 follows 108. A path of light from the emitter 103 reflected off the second remote object 701 and onto the sensor 201 follows 702. It will be appreciated that light reflected from the reference object 105 may reflect onto the sensor 201 at time t1, light reflected from the first remote object 106 may reflect onto the sensor 201 at time t2 and light reflected from the second remote object 701 may reflect onto the sensor 201 at time t3. Similarly to the embodiments described in relation to FIGS. 4 and 5, a detection period may occur in which light is emitted from the emitter 103, reflected off the objects 105, 106 and 701, picked up by the sensor 201 (events triggered) to generate event and time information and used to build a histogram.

FIG. 7B shows an example of a histogram generated in response to the detection period. It will be appreciated that in this case, there will be three peaks—a first peak 303 due to the events triggered by reflection off the reference object 105, a second peak 304 due to the events triggered by reflection off the first remote object 106 and a third peak 710 due to the events triggered due to the reflection off the third remote object 701. The distance on the histogram (or time difference) between the first and second peaks 303 and 304 may correspond to the distance between the reference object 105 and the first remote object 304. The distance on the histogram (or time difference) between the first and third peaks 303 and 710 may correspond to the distance between the reference object 105 and the second remote object 710. The time difference between the first and third peak may be determined by detecting a position of each of the peaks and comparing the time at which the peaks were detected. This time difference may then be used to calculate distance.

It will be appreciated that while FIGS. 7A and 7B show only two remote objects, the histogram may be used to detect further remote objects.

It will be appreciated the while the foregoing describes an arrangement which relies on a pulsed input waveform, it should be noted that the technique of using a single array to extract a reference, or calibration, path in addition to the target path could be used for ToF systems utilizing other techniques, for example using a light source emitting a sinusoidal waveform. In this example, during the detection period, the emitter may a light frequency and time and event information may be generated for each period of the emitted frequency until the end of a detection period.

It will be appreciated that embodiments of the disclosure may be implemented in a wide variety of applications. For example ranging data extracted from the return and reference peak subtraction according to embodiments could be used for a large number of applications including user detection, auto-focus assist and machine vision. In the foregoing a sensor 201 has been depicted. It will be appreciated that in some embodiments, the sensor 201 may be a single photon avalanche diode array. It will be appreciated that a photon of light (as part of the light emitted from the emitter 103) may trigger an avalanche current in a SPAD and thus cause an output of an indication of an event.

In the foregoing an emitter 103 has been described. It will be appreciated that in some embodiments, the emitter may be a vertical surface cavity emitting laser (VSCEL) and may be driven by a VSCEL driver. However it will be appreciated that this is by way of example only and other suitable emitters may be used.

In the foregoing a device 200 is described. In some embodiments the device may be part of a mobile phone, for example part of a touch screen on a mobile phone or other device. It will be appreciated however that the device may be incorporated in any apparatus that requires a determination of distance.

1. A method, comprising:
determining a plurality of first events corresponding to detecting a reflection off a reference object;
determining a plurality of second events corresponding to detecting a reflection off a remote object;
generating a histogram having a first peak corresponding to the plurality of first events and a second peak corresponding to the plurality of second events; and
determining a distance between the remote object and the reference object in dependence on a time between the first peak and the second peak.

2. The method of claim 1 further comprising emitting a series of light pulses that cause the first events and second events.

3. The method of claim 1 wherein the reference object is part of a sensing device.

4. The method of claim 1 wherein each of the plurality of first events and the plurality of second events comprises an indication that an event has occurred and an event time.

5. The method of claim 4 wherein the event time comprises a time period between a light pulse being triggered and the event being determined.

6. The method of claim 1 wherein the histogram is generated by a time to digital converter.

7. The method of claim 1 wherein the histogram comprises an indication of the likelihood of an event occurring against time.

8. The method of claim 1 wherein the time between the first peak and the second peak of the histogram is indicative of a distance between the remote object and the reference device.

9. The method of claim 1 wherein the determining the pluralities of first events and second events is carried out by a first sensor array.

10. The method of claim 1 wherein the reference object is at a known distance to an emitter of the light.

11. The method of claim 1 further comprising:
determining a plurality of further events corresponding to detecting a reflection off a further remote object;
generating the histogram further having a further peak corresponding to the plurality of further events; and
determining a distance between the further remote object and the reference object in dependence on a time between the first peak and the further peak.

12. An apparatus, comprising:
an emitter configured to emit light for a detection period; and
a sensor for detecting reflected light and providing event information relating to the detected of light;
a processing device coupled to the emitter and sensor and configured to:
determine a plurality of first events corresponding to detecting a reflection off a reference object;
determine a plurality of second events corresponding to detecting a reflection off a remote object;
generate a histogram having a first peak corresponding to the plurality of first events and a second peak corresponding to the plurality of second events; and
determine a distance between the remote object and the reference object in dependence on a time between the first peak and the second peak.

13. The apparatus of claim 12 further comprising:
a time to digital converter for providing time and event information corresponding to the detected light.

14. A method, comprising:
emitting a plurality of pulses of light;
sensing with a sensor a plurality of first light sensing events corresponding to detecting a reflection of the emitted pulses of light off a reference object;
sensing with said same sensor a plurality of second light sensing events corresponding to detecting a reflection of the emitted pulses of light off a remote object;
generating a histogram having a first peak corresponding to a first time of sensing the plurality of first light sensing events and a second peak corresponding to a second time of sensing the plurality of second light sensing events; and
determining a distance between remote object and the reference object in dependence on a difference between the first and second times.

15. The method of claim 14, wherein said sensor is a SPAD with a time to digital converter.

16. The method of claim 14 wherein the reference object is part of a housing for the sensor.

17. The method of claim 14 wherein the histogram comprises an indication of the likelihood of an event occurring against time.

18. The method of claim 14 wherein the reference object is at a fixed distance to an emitter of the plurality of pulses of light.
